(19) United States
(12) Patent Application Publication
(10) Pub. No.: US 2023/0098476 A1
(43) Pub. Date: Mar. 30, 2023

(54) MODULAR FLEXIBLE GRIP FOR HAIR REMOVAL DEVICE

(71) Applicant: Braun GmbH, Kronberg (DE)

(72) Inventors: Jinhao Cui, Beijing (CN); Pu Xiao, Beijing (CN); Yi Li, Beijing (CN)

(21) Appl. No.: 17/954,459

(22) Filed: Sep. 28, 2022

(30) Foreign Application Priority Data
Sep. 30, 2021 (CN) 2021121993

(51) Int. Cl. B25G 1/02; B25G 1/10

(52) U.S. Cl. CPC B25G 1/02; B25G 1/102

(57) ABSTRACT

A modular flexible grip for releasably attaching to at least a part of a hair removal device. The grip includes a flexible body portion having a body portion opening and a side wall in the opening defining a body cavity. The grip is characterized by a height greater than or equal to 50 mm. The grip is configured for releasably attaching to the least a part of a hair removal device.

### FIELD OF THE INVENTION

The present invention relates to modular flexible grips for hair removal devices, and specifically relates to a modular flexible grip for releasably attaching to at least one part of a hair removal device, a modular flexible grip system for a hair removal device, and a method of modifying an appearance and improving grip resistance of a hair removal device.

### BACKGROUND OF THE INVENTION

Many handheld devices are provided with grip elements which provide users with a soft-touch, rubber-like feel to reduce slipping and improve tactile feel. For handheld devices with handles made of molded plastic, conventional grips have been integrated with the handle by using a first plastic material to mold the housing, and overmolded with a second softer plastic such as an elastomeric material to define a handle portion for the device. While an integrated hand grip provides anti-slip and tactile feel benefits, visual decorative elements can be insert-molded for providing a visual effect, the grip cannot be easily interchanged thereby limiting a user's ability to customize an appearance of the device. Further, only certain plastic materials can be molded with elastomeric materials, and there are materials which are not compatible for molding with elastomeric materials such as ceramics. Therefore, this may limit the selection of materials for making consumer products with grips or gripping functions.

US Patent Application Publication No. US2003/123917A1 describes a deformable sleeve for attachment to various products for use as a grip or to provide a stylish appearance. The deformable sleeve is provided with two membranes that defined a cavity filled with a formable material. A tubular sleeve for a pen or a pencil with handles that are cylindrical or that have a curved or oval cross section is shown in FIGS. 5 to 9 of US2003/123917A. The sleeve can be permanent or temporary and can be removed and replaced. However, the sleeve only covers cylindrical shapes. For a three-dimensional body having an elongate shape with six sides such as a camera, two deformable patches are mounted on the camera to partially cover four surfaces of the camera (front, back, left, right surfaces) held by a user. The patches may be mechanically attached to the surfaces through adhesive means. However, a disadvantage of mechanical means such as adhesives is that adhesives may leave residue on surfaces after removal of the patch. It is also difficult to adhere such patches evenly on consumer products with complex three-dimensional shapes.

Specifically, hair removal devices such as electric shavers and intense pulsed lighting (IPL) devices include handles with complex three-dimensional shapes including elongate rectangular, square, circular, or elliptical shape. International Publication No. WO2007072378A2 describes a grip having a rigid frame for providing a dedicated shape which allows manufacturing of complex three-dimensional shapes for appliances. However, the addition of a rigid frame results in more parts and/or raw materials used in making the grip.

Therefore, there remains a continuing need to provide a grip for a hair removal device that can be easily attached to the device to improve grip resistance during handling of the device, and easily detached for enabling customization of a visual appearance of the device.

### SUMMARY OF THE INVENTION

The present invention relates to a modular flexible grip for releasably attaching to at least a part of a hair removal device, the grip comprising:

a flexible body portion comprising a body portion opening and a side wall in the opening defining a body cavity;

wherein the side wall comprises a proximal end at a periphery of the opening and a distal end;

an adjoining member located at the distal end; wherein the side wall circumscribes the adjoining member to define a shroud for covering at least a part of a hair removal device;

wherein the body portion is characterized by a height greater than or equal to 50 mm;

wherein the grip is configured for releasably attaching to the least a part of a hair removal device.

### BRIEF DESCRIPTION OF THE DRAWINGS

FIG. 1 is a front perspective view of a hair removal device with a cover;

FIG. 2 is a front perspective view of a hair removal device without a cover;

FIG. 3 is a front perspective view of a hair removal device and a modular flexible grip system in an interference fit assembly according to the present invention, a cover of the hair removal device is not attached to expose a hair removal head of the hair removal device;

FIG. 4 is a front view of the hair removal device and the modular grip system of FIG. 3 with the cover attached to the hair removal device;

FIG. 5 is a side section view of FIG. 4;

FIG. 6 is a front view of a first modular flexible grip for a handle portion of a hair removal device according to the present invention;

FIG. 7 is a side view of the first grip of FIG. 6;

FIG. 8 is a bottom view of the first grip of FIG. 6;

FIG. 9 is a schematic view of a horizontal cross section of at least a part of a hair removal device and a horizontal cross section of a grip according to the present invention in a maximum interference fit assembly with the at least a part of the hair removal device;

FIG. 10 is a schematic view of a horizontal cross section of at least a part of a hair removal device and a horizontal cross section of a grip according to the present invention, the grip configured for receiving an insert for providing an interference fit assembly or friction fit with the at least a part of the hair removal device;

FIG. 11 is a schematic view of a front cross section of at least a part of a hair removal device and a horizontal cross section of a grip according to the present invention, the grip configured for receiving an insert for providing a pressure fit with the at least a part of the hair removal device;

FIG. 12 is a front view of a second modular flexible grip for a cover for a hair removal head of a hair removal device according to the present invention;

FIG. 13 is a side view of the second grip of FIG. 12;

FIG. 14 is a bottom view of the second grip of FIG. 12;

FIG. 15 is a plan view of a grip having a variation of an aperture according to the present invention;

FIG. 16 is a plan view of a grip having an alternative variation of an aperture according to the present invention; and

FIG. 17 is a plan view of a grip having a further alternative variation of an aperture according to the present invention.

### DETAILED DESCRIPTION OF THE INVENTION

The invention relates to a modular flexible grip for releasably attaching to at least a part of a hair removal device, a modular grip system for a hair removal device and a method for modifying an appearance of a hair removal device. The modular flexible grip generally relates to grips for handheld devices. The term “grip” as used herein, refers to removable attachments for hair removal devices to facilitating holding and maintaining control of the hair removal devices by a user during operation or use of the hair removal device and does not include storage cases for storing hair removal devices. The term “releasably attached” as used herein, refers to removable securing, joining, connecting, friction fit, pressure fit, interference fit, fastening of the grip to at least a part of a hair removal device so as to securely hold to the at least a part of a hair removal device and resist unintentional removal in use. The term “interference fit” is well known and will not be further described. The term “friction fit” as described herein refers to the grip attached to the device but having a gap from 0 mm to 5 mm or a gap sufficient for the grip to be secured to at least a part of the hair removal device without unintentional removal in use, and the grip contacts the at least a part of the hair removal device upon gripping in use by the user. The term “pressure fit” as described herein refers to the grip attached to the device by resilient properties of the grip material as described with reference to FIG. 11 described hereinafter. Specifically, when energy is used to expand or deform the grip for attaching to the at least a part of the hair removal device, the grip is in a deformed/extended state. When the energy is released after the grip is attached to the at least a part of the hair removal device, the grip returns to a non-deformed (original state) and having a gap from 0 mm to 5 mm or a gap sufficient for the grip to be secured to at least a part of the hair removal device without unintentional removal in use.

The modular grip described herein is designed to be attached to the device to improve grip resistance during handling of the device, and can be easily detached for enabling customization of a visual appearance of the device. The grip may be designed, shaped or otherwise configured with features to resist unintentional removal, and provides improved gripping resistance upon attaching the grip with the at least a part of a hair removal device. The grip may comprise a shroud, wherein a shape of the shroud corresponds to an outer profile of the at least a part of a hair removal to provide a form-fit to the user's hand prior to or in use. The grip may be configured for releasably attaching to the at least a part of a hair removal device by one of: interference fit, pressure fit, friction fit, and combinations thereof.

In the following description, the modular grip comprises a flexible body portion having a body cavity modified to allow a cover or a handle portion of the hair removal device to be releasably attached to the body portion in an interference fit. The hair removal device is an electronically operated hair removal device, such as a shaver having a hair removal head, like a shaver head including at least one cutter element. A hair removal device may include but is not limited to an electric shaver or an epilator. The flexible body portion is made of a flexible material such as a polymeric material. However, it is contemplated that the modular grip may be configured for use in a variety of applications to improve grip resistance and enable customization of a visual appearance of handheld consumer products including but not limited to hair removal devices, handheld oral care or skin care devices.

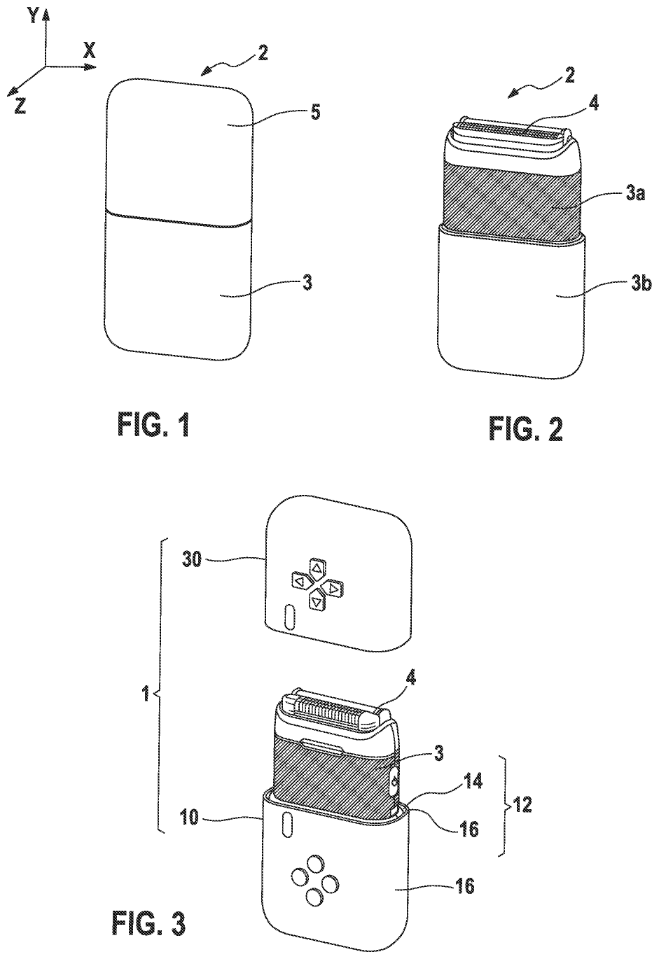

FIG. 1 is a front perspective view of a hair removal device 2 with a cover 5 and FIG. 2 is a front perspective view of the hair removal device 2 of FIG. 1 without the device cover 5. Referring to FIG. 1, the hair removal device 2 comprises a handle portion 3, a hair removal head 4 (shown in FIG. 2) on the handle portion 3, and the cover 5 attached to the handle portion 3 for covering the hair removal head 4. FIG. 3 is a front view of the hair removal device 2 and a modular flexible grip system 1 according to the present invention releasably attached to the hair removal device 2. Referring to FIG. 2, it can be seen that the handle portion 3 can comprise an upper portion 3a with a different finish from the bottom portion 3b, and is sized to enable the cover 5 to be attached to the bottom portion 3b.

Referring to FIG. 3, the modular grip system 1 comprises a first modular grip 10 and a second modular grip 30, each of the modular grips 10, 30 are configured for releasably attaching to at least a part of the hair removal device 2. In FIG. 3, the modular grip system 1 comprises the first modular grip 10 releasably attached to the handle portion 4 of the hair removal device 2 and the second modular grip 30 releasably attached to the cover 5. The grip 10, 30 may be constructed of a flexible material characterized by an elongation at break from 100% to 2000%, preferably from 200% to 1600%. The grip 10, 30 may be constructed of a flexible material characterized by a hardness not greater than 100 Shore A, preferably from 5 Shore A to 100 Shore A, more preferably from 5 to 95 Shore A. The grip 10, 30 may be constructed from a material selected from the group consisting of: thermoplastic polyurethane, thermoplastic elastomer, silicone rubber, rubber, a polymeric material and mixtures thereof.

In the following description, the width, height and depth, aspect ratio of a modular grip according to the present invention is described with respect to the size, shape and the aspect ratio of the at least a part of the hair removal device 2, but it is contemplated that the modular grip can be configured according to different size, shape and aspect ratios of other handheld devices including other hair removal device designs so as to achieve the same technical effect of improved grip and customizable appearance for hair removal devices of different shapes and sizes.

Referring to FIG. 3, the modular grip 10, 30 comprises a flexible body portion 12 including a body portion opening 14 and a side wall 16 in the opening 14 defining a body cavity 18 (shown in FIG. 5) for receiving at least a part of the hair removal device 2. The body portion 12 is configured for releasably attaching to the least a part of a hair removal device 2 by interference fit of the body portion 12 with the at least a part of the hair removal device 2 upon inserting the at least a part of the hair removal device into the body cavity.

The modular grip comprises a width, height and depth along the x-axis, y-axis, and z-axis respectively. The at least a part of the hair removal device 2 may be the cover 2 or the handle portion 3, and comprises a width, height and depth along the x-axis, y-axis, and z-axis respectively. The at least a part of the hair removal device 2 may be elongate in that its aspect ratio, or width to height ratio is from 1:5 to 1:1, from 1:5 to 1:1.3, from 1:4 to 1:1.5, from 1:3 to 1:1.9 or different combinations of the upper and lower numerical values described above or combinations of any numerical value in the ranges listed above. Table 1 below illustrates exemplary physical characteristics including dimensions and aspect ratios of different hair removal devices for which a grip according to the present invention can be configured for releasable attachment to.

TABLE 1

| Hair Removal | Width | Height | Depth | Aspect Ratio |
|---|---|---|---|---|
| Device | (mm) | (mm) | (mm) | (W:H) |
| Shaver Example | 60 | 110 | 27 | 1:1.8 |
| of FIG. 1 | | | | |
| Example IPL | 68 | 180 | 50 | 68:180 (1:2.6) |
| Device A (Not | | | | |
| shown) | | | | |
| Example IPL | 72 | 134 | 49 | 72:134 (1:1.9) |
| Device B (Not | | | | |
| shown) | | | | |
| Alternative | 64 | 166 | 51 | 64:166 (1:2.6) |
| Shaver Example | | | | |
| (Not shown) | | | | |

Accordingly based on the physical characteristics of different hair removal devices described above, the aspect ratio, width, height and depth of the modular grip can be configured to define a body cavity for interference fit with the at least a part of the hair removal device 2.

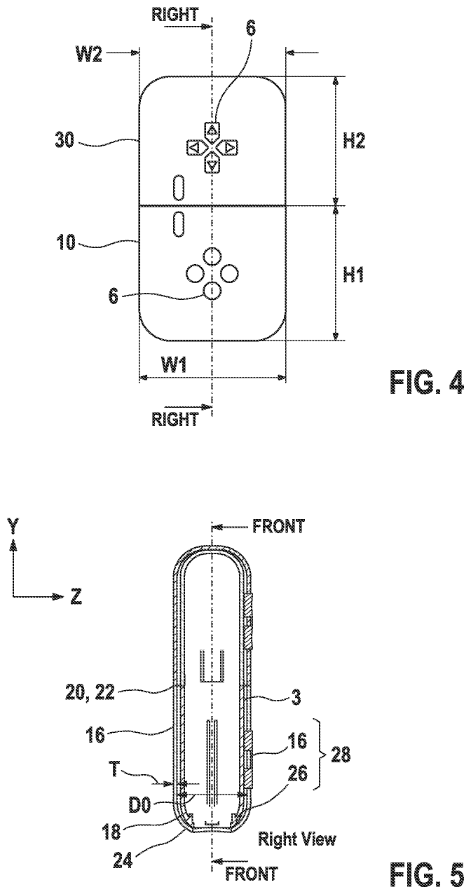

Referring to FIG. 4, each modular grip 10, 30 is further characterized by a height H1, H2 greater than or equal to 50 mm A technical effect of the grip 10, 30 having a height greater than or equal to 50 mm is that it extends along the palm of the hand and provides an improved ergonomic handling of the hair removal device 2 when assembled with the grip 10, 30. A grip that has a height, i.e. less than 50 mm, such as for example, 20 mm, may cause unnecessary compression in the middle of the palm or may be insufficient for preventing slipping.

The modular grip may be characterized by an overall width to height ratio defining an aspect ratio of from 1:5 to 1:1, from 1:5 to 1:1.3, from 1:4 to 1:1.5, from 1:3 to 1:1.9 or different combinations of the upper and lower numerical values described above or combinations of any numerical value in the ranges listed above. A technical effect of the aspect ratio is that it enables a good grip between the hand of the user and the hair removal device 2. Decorative elements 6 may be disposed on or integral with the first modular grip 10 or the second modular grip 30 for customizing an appearance of the hair removal device 4 according to consumer preferences.

FIG. 5 is a side section view of the hair removal device 2 with the modular grip system 1 of FIG. 3. Specifically, the first modular grip 10 is in contact with an outer surface of the handle portion 3 to define a releasable interference fit assembly. The side wall 16 comprises a proximal end 20 at a periphery 22 of the opening 14 and a distal end 24. An adjoining member 26 is located at the distal end 24 wherein the side wall 16 circumscribes the adjoining member 26 to define a shroud 28. A shape of an inner surface of the body portion 12 may correspond to an outer profile of the at least a part of a hair removal device as shown in FIG. 1. The adjoining member 26 may comprise a profile corresponding to an outer profile of at least a part of the hair removal device 2. The side wall 16 may be characterized by a thickness T of at least 0.5 mm, preferably from 0.5 mm to 2 mm A technical effect of a thickness T in the range of from 0.5 mm to 2 mm is that the grip 10 may be mechanically robust so as to be tear resistant while not increasing an overall thickness or width of the hair removal device 2.

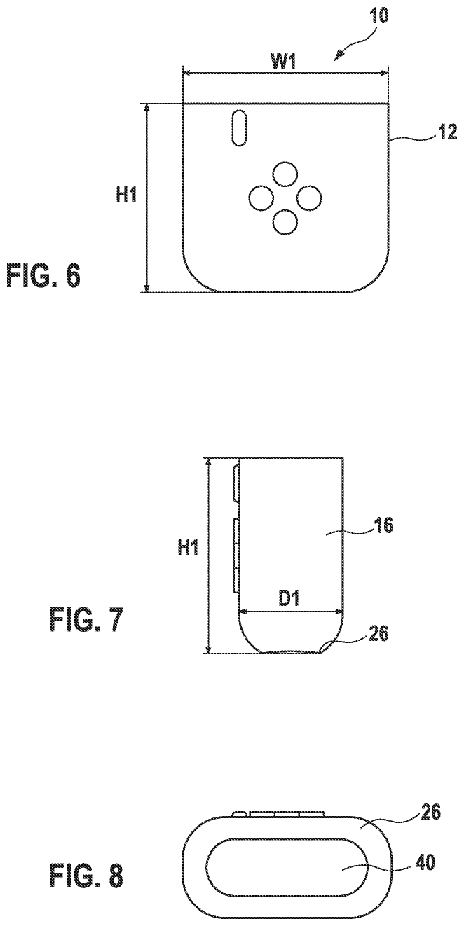

FIG. 6 is a front view of the first modular grip 10 according to the present invention. FIG. 7 is a side view of the first grip 10 and FIG. 8 is a bottom view of the first grip 10. Referring to FIG. 6, the first grip 10 may be characterized by an aspect ratio of from 1:5 to 1:1, from 1:5 to 1:1.3, from 1:4 to 1:1.5, from 1:3 to 1:1.9 or different combinations of the upper and lower numerical values described above or combinations of any numerical value in the ranges listed above. The aspect ratio is defined by a width W1 to height H1 ratio of the grip 10. The first grip 10 further comprises a depth D1 as shown in FIG. 7.

Referring to FIG. 8, the adjoining member 26 define a rim at the distal end 24 and the grip 10 may comprise an aperture 40 disposed in the adjoining member 26. A technical effect of having an aperture 40 is to enable ease of detaching the grip 10 from the hair removal device. A further technical effect is that the aperture 40 may be aligned with a charging port of the hair removal device wherein the charging port is located at the bottom of the handle portion of the hair removal device.

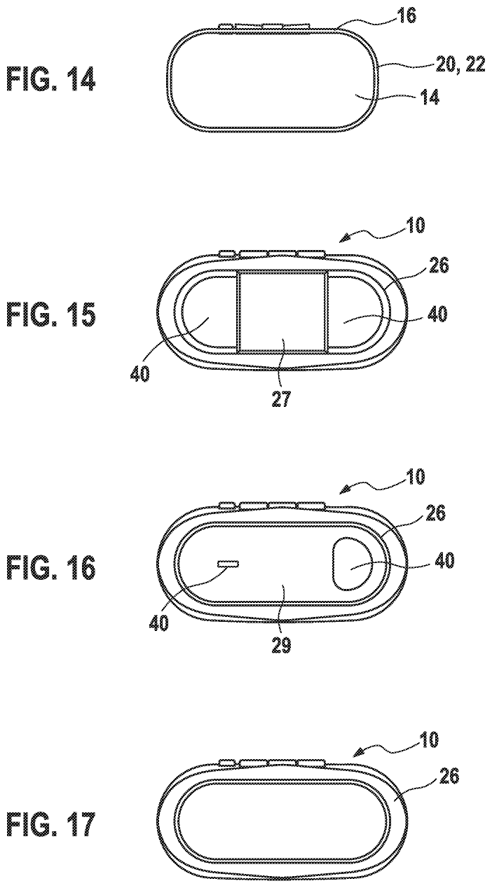

The aperture 40 may be characterized by a shape defined by a horizontal cross section of the hair removal device. However, it will be appreciated that the aperture 40 may comprise other shapes such as shown in FIGS. 14 and 15. The adjoining member 26 may also be substantially free of an aperture such as shown in FIG. 16.

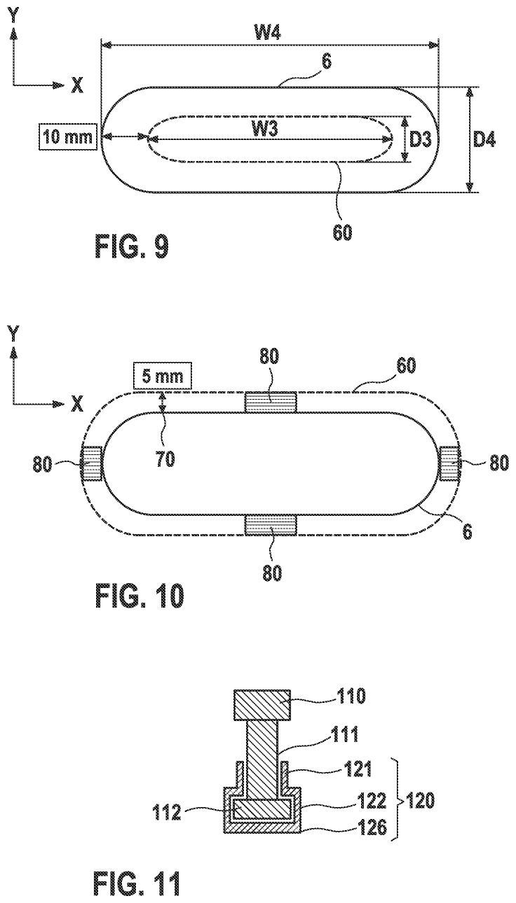

FIG. 9 is a schematic view of a horizontal cross section of at least a part of a hair removal device and a horizontal cross section of a grip 10, 30 according to the present invention in an interference fit assembly with the at least a part of the hair removal device. The grip 10, 30 may comprise an interference fit of not greater than −10 mm, preferably from −10 mm to −0.01 mm.

Specifically, the interference fit may be defined by a difference between a distance between an outer surface 6 of the at least a part of the hair removal device and an inner surface 60 of the body portion 12. As shown in FIG. 9, the grip comprises a maximum interference fit of −10 mm along the x-axis. In other words, the grip 10, 30 is smaller in width W3 and depth D3 relative to width W4 and depth D4 of the at least a part of the hair removal device. A technical effect of the maximum interference fit is that beyond the maximum interference fit, it may be difficult to attach and/or pull or separate the grip from the hair removal device.

FIG. 10 is a schematic view of a horizontal cross section of at least a part of a hair removal device and a horizontal cross section of a grip 10, 30 according to the present invention. Specifically, the grip 10, 30 may be sized to provide a gap 70 of less than or equal to 5 mm between the inner surface 60 of the body portion 12 in x axis, and y axis respectively.

In an embodiment, the body portion 12 may be configured with one or more ribs 80 disposed on the inner surface 60. The one or more ribs 80 may be sized for providing an interference fit assembly or friction fit with the at least a part of the hair removal device.

FIG. 11 is a schematic view of a front cross section of at least a part of a hair removal device 110 having an irregular or non-uniform geometry and a grip 120 according to the present invention is releasably attached by pressure fit by internal resilience properties of the grip 120. Specifically, there is a gap between the grip 120 and the at least a part of a hair removal device 110. The grip 120 comprises a body portion 12 similar to the grip 10 of FIG. 1 and differs in an inner surface 126 of the body portion 12 may have a shape corresponding to a shape of an outer surface 111 of the at least a part of a hair removal device 110 for enabling pressure fit with the at least a part of a hair removal device. Specifically, the grip 120 has a first cross section 121 narrower than a second cross section 122 and the grip 120 is made of a flexible material with resilient properties and can be deformed to slidably move past a shoulder portion 112 of the at least a part of the hair removal device 110 and slidably shroud the at least a part of the hair removal device 110. Specifically, the grip 120 has resilient properties so as to enable the grip 120 to return to a non-deformed state when the second cross section 122 eventually reach and slidably shrouds the shoulder portion 112.

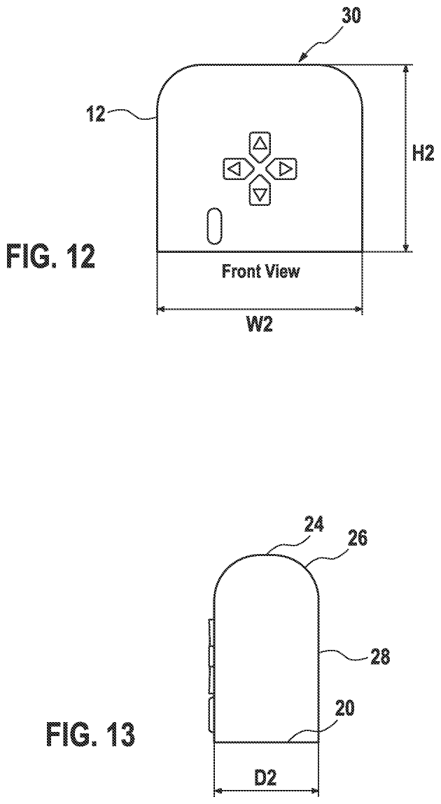

FIG. 12 is a front view of a second modular grip 30 for a cover for a hair removal head of a hair removal device according to the present invention. FIG. 13 is a side view of the second grip 30 and FIG. 14 is a bottom view of the second grip 10. The second grip 10 has substantially the same features of the first grip 10 and differs in that there is no aperture in the adjoining member of the second grip 30. Similar to the first grip 10, the second grip 30 may comprise an aspect ratio of from 1:5 to 1:1, from 1:5 to 1:1.3, from 1:4 to 1:1.5, from 1:3 to 1:1.9 or different combinations of the upper and lower numerical values described above or combinations of any numerical value in the ranges listed above. Referring to FIG. 13, the second grip 30 comprises a proximal end 20, a distal end, and an adjoining member 26 located at a distal end 24 wherein the side wall (not shown) circumscribes the adjoining member 26 to define a shroud 28 for covering at least a part of a hair removal device. The adjoining member 26 of the second grip 30 is substantially free of an aperture and defines a top of the second grip. However, it will be appreciated that the adjoining member 26 may also comprise an aperture 40. FIG. 14 shows an opening 14 disposed in the bottom view of the second grip for inserting the cover 5 of the hair removal device.

FIGS. 15 to 17 each illustrate a plan view of a grip having substantially the same features as a grip 10 of FIG. 6 except with different variations of an aperture in an adjoining portion according to the present invention. Referring to FIG. 15, the grip 10 may comprise an adjoining member 26 comprising a rim at a distal end 24 and a center portion 27 extending across opposite sides of the rim to define two apertures 40 of the substantially the same shape and size in the adjoining member 26.

Alternatively, referring to FIG. 16, the grip 10 may comprise an adjoining member 26 comprising a rim at a distal end 24 and a major portion 29 extending across opposite sides of the rim to define two apertures 40 with different sizes and shapes in the adjoining member 26.

Further, referring to FIG. 17, the grip 10 may comprise an adjoining member 26 substantially free of an aperture 40. To facilitate ease of releasably attaching to the at least a part of the hair removal device, the grip 10 may be configured to have a gap 70 and with ribs 80 for providing an interference fit as shown in FIG. 10 The present invention also relates to a method of modifying an appearance and improving a grip resistance of a hair removal device, the method comprising:

providing a hair removal device comprising a handle portion and a hair removal head on the handle portion;

providing a grip according to the present invention;

inserting the handle portion and/or the hair removal head into the body cavity of the grip to modify the appearance and improving a grip resistance of the hair removal device.

Representative embodiments of the present disclosure described above can be described as set out in the following paragraphs:

A. A modular flexible grip (10, 30) for releasably attaching to at least a part of a hair removal device (2), the grip (10, 30) comprising:
a flexible body portion (12) comprising a body portion opening (14) and a side wall (16) in the opening (12) defining a body cavity (18);
wherein the side wall (16) comprises a proximal end (20) at a periphery (22) of the opening (14) and a distal end (24);
an adjoining member (26) located at the distal end (24); wherein the side wall (16) circumscribes the adjoining member (26) to define a shroud (28) for covering at least a part of a hair removal device;
wherein the grip (10, 30) is characterized by a height (H) greater than or equal to 50 mm;
wherein the grip (10, 30) is configured for releasably attaching to the least a part of a hair removal device (2).

B. The grip (10, 30) according to paragraph A, wherein a shape of an inner surface of the body portion (12) corresponds to an outer profile of the at least a part of a hair removal device.

C. The grip (10, 30) according to paragraph A or paragraph B, wherein the grip is configured for releasably attaching to the at least a part of a hair removal device by one of: interference fit, pressure fit, friction fit, and combinations thereof.

D. The grip (10, 30) according to any one of the preceding paragraphs, wherein the grip (10, 30) is characterized by an aspect ratio of from 1:5 to 1:1, wherein the aspect ratio is defined by a width to height ratio of the grip (10, 30).

E. The grip (10, 30) according to any one of the preceding paragraphs, wherein the side wall (16) is characterized by a thickness of at least 0.5 mm, preferably from 0.5 mm to 2 mm.

F. The grip (10, 30) according to any one of the preceding paragraphs, wherein the grip (10, 30) is constructed of a flexible material characterized by an elongation at break from 100% to 2000%, preferably from 200% to 1600%.

G. The grip (10, 30) according to any one of the preceding paragraphs, wherein the grip (10, 30) is constructed of a flexible material characterized by a hardness not greater than 100 Shore A, preferably from 5 Shore A to 100 Shore A, more preferably from 5 to 95 Shore A.

H. The grip (10, 30) according to any one of the preceding paragraphs, wherein the grip (10, 30) is constructed from a material selected from the group consisting of: thermoplastic polyurethane, thermoplastic elastomer, silicone rubber, rubber, a polymeric material and mixtures thereof.

I. The grip (10, 30) according to any one of the preceding paragraphs, wherein the grip (10, 30) comprises an aperture (40) disposed in the adjoining member (26).

J. The grip (10, 30) according to paragraph I, wherein the aperture (40) is characterized by a shape defined by a horizontal cross section of the body portion (12).

K. The grip (10, 30) according to paragraph I or paragraph J, wherein the aperture (40) is aligned with a charging port of the hair removal device (2).

L. A hair removal device (2) comprising a handle portion (3), a hair removal head (4), and a first grip (10) releasably attachable to the handle portion (3), wherein the first grip (10) is a grip according to any one of paragraphs A to K.

M. The hair removal device (2) according to claim 11, further comprising a cover for the hair removal head, and a second grip (30) releasably attached to the cover, wherein the second grip is a grip according to any one of paragraphs A to K.

N. A modular flexible grip system (1) for a hair removal device (2) comprising a handle portion (3) and a hair removal head (4), the system (1) comprising:
a first grip (10) for the handle portion (3);
a second grip (30) for the hair removal head (4);
wherein each of the first and second grips (10, 30) is according to a grip according to any one of paragraphs A to K.

O. A method of modifying an appearance and improving grip resistance of a hair removal device (2) comprising:
providing a hair removal device (2) comprising a handle portion (3) and a hair removal head (4);
providing a grip (10, 30) according to any one of paragraphs A to K;
inserting the handle portion (3) or the hair removal head (3) into the body cavity (18) of the grip (10, 30) to modify the appearance and improve grip resistance of the hair removal device (2).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A modular flexible grip for releasably attaching to at least a part of a hair removal device, the grip comprising:
a flexible body portion comprising a body portion opening and a side wall in the opening defining a body cavity;
wherein the side wall comprises a proximal end at a periphery of the opening and a distal end;
an adjoining member located at the distal end; wherein the side wall circumscribes the adjoining member to define a shroud for covering at least a part of a hair removal device;
wherein the grip is characterized by a height (H) greater than or equal to 50 mm;
wherein the grip is configured for releasably attaching to the least a part of a hair removal device.

2. The grip according to claim 1, wherein a shape of an inner surface of the body portion corresponds to an outer profile of the at least a part of a hair removal device.

3. The grip according to claim 1, wherein the grip is configured for releasably attaching to the at least a part of a hair removal device by one of: interference fit, pressure fit, friction fit, and combinations thereof.

4. The grip according to claim 1, wherein the grip is characterized by an aspect ratio of from 1:5 to 1:1, wherein the aspect ratio is defined by a width to height ratio of the grip.

5. The grip according to claim 1, wherein the side wall is characterized by a thickness of at least 0.5 mm, preferably from 0.5 mm to 2 mm.

6. The grip according to claim 1, wherein the grip is constructed of a flexible material characterized by an elongation at break from 100% to 2000%, preferably from 200% to 1600%.

7. The grip according to claim 1, wherein the grip is constructed of a flexible material characterized by a hardness not greater than 100 Shore A, preferably from 5 Shore A to 100 Shore A, more preferably from 5 to 95 Shore A.

8. The grip according to claim 1, wherein the grip is constructed from a material selected from the group consisting of: thermoplastic polyurethane, thermoplastic elastomer, silicone rubber, rubber, a polymeric material and mixtures thereof.

9. The grip according to claim 1, wherein the grip comprises an aperture disposed in the adjoining member.

10. The grip according to claim 9, wherein the aperture is characterized by a shape defined by a horizontal cross section of the body portion.

11. The grip according to claim 9, wherein the aperture is aligned with a charging port of the hair removal device.

12. A hair removal device comprising a handle portion, a hair removal head, and a first grip releasably attachable to the handle portion, wherein the first grip is a grip according to claim 1.

13. The hair removal device according to claim 12, further comprising a cover for the hair removal head, and a second grip releasably attached to the cover, wherein the second grip is a grip according to claim 1.

14. A modular flexible grip system for a hair removal device comprising a handle portion and a hair removal head, the system comprising:
a first grip for the handle portion;
a second grip for the hair removal head;
wherein each of the first and second grips is according to a grip according to claim 1.
